(19) United States
(12) Patent Application Publication
(10) Pub. No.: US 2009/0111440 A1
(43) Pub. Date: Apr. 30, 2009

(54) DATA PROCESSING UNIT AND METHOD, IN PARTICULAR FOR PROCESSING INFORMATION REQUEST MESSAGES SENT OVER A TELEPHONE NETWORK

(76) Inventor: Gaetano Rizzi, Busto Arsizio (IT)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/295,966

(22) PCT Filed: Mar. 23, 2007
(86) PCT No.: PCT/IB07/00724

§ 371 Date: Dec. 24, 2008

(30) Foreign Application Priority Data
Apr. 7, 2006 (IT) TO2006A000256

(51) Int. Cl. H04W 4/12; H04M 3/42

(52) U.S. Cl. 455/414.4; 455/466

(57) ABSTRACT

A data processing unit is described which comprises a reception module for receiving request messages sent by a user terminal over a telephone network, a decoder module, which communicates with said reception module and which is adapted to extract a text from a received request message, and a reply module for generating a reply message. The invention is characterized in that a reply message is generated which contains a text in at least one language defined on the basis of one or more features associated with said request message.

The present invention relates to a data processing unit according to the preamble of claim 1 and to a data processing method according to the preamble of claim 13.

Systems are known which grant access to databases hosted in a remote data processing unit through a message sent by a user terminal.

The message is typically SMS (Short Message System) type in order to use less band, but it may be MMS (Multimedia Message System) type as well.

A widespread application of these systems relates to multimedia file request services: the user sends an SMS, and a central server replies by sending the requested file.

These kinds of applications are increasingly used and new services are available everyday.

More interactive applications are also known which grant both read and write access to the database. A typical application already on the market is the one which allows sales agents to gain access (through SMS) to the company database in order to receive information about products or to upload new orders relating to a certain project.

In both of these types of applications, in the remote data processing unit the SMS message is processed and a database access query is identified. Subsequently, if any information has been requested, it is sent to the calling user via SMS.

The problem of these systems is related to the format of the text of the SMS message. As far as syntax errors are concerned, they are usually limited thanks to the fact that the SMS system utilizes very synthetic texts (e.g. the text “MUSICA 012” is used for identifying the song to be downloaded from the database) or thanks to the use of dedicated applications available in the mobile telephone.

The Applicant has noticed a further problem related to another aspect of message formatting: the language.

If a foreign user (e.g. an English user) uses a language other than that required by the service (e.g. an Italian service), the message will not be decoded and no reply will be sent by the remote data processing unit (other than a possible syntax error message).

Vice versa, should the foreign user try to use the required language and write a correct message, the information returned might be unintelligible and therefore useless.

De facto, therefore, the current systems do not offer any flexibility in formatting the database access message, resulting in a large number of database access errors.

Such a rigidity is even more problematical when, for example, the information returned by the remote computer must be used or processed in a user's local database operating in a different language, i.e. which requires reply information to be formatted differently.

The object of the present invention is to provide the data processing unit with higher flexibility than in known solutions.

This and other objects of the present invention are achieved through a data processing unit and method comprising the features set out in the appended claims, which are intended as an integral part of the present description.

As a matter of fact, such a system offers the advantage that several types of formats can be used for writing the database access message.

The data processing unit according to the invention can also advantageously return information in one or more formats, possibly privileging one specific format depending on the elements making up the message, such as the language or the telephone number.

Further objects and advantages of the present invention will become apparent from the following description and from the annexed drawings, supplied by way of non-limiting example, wherein:

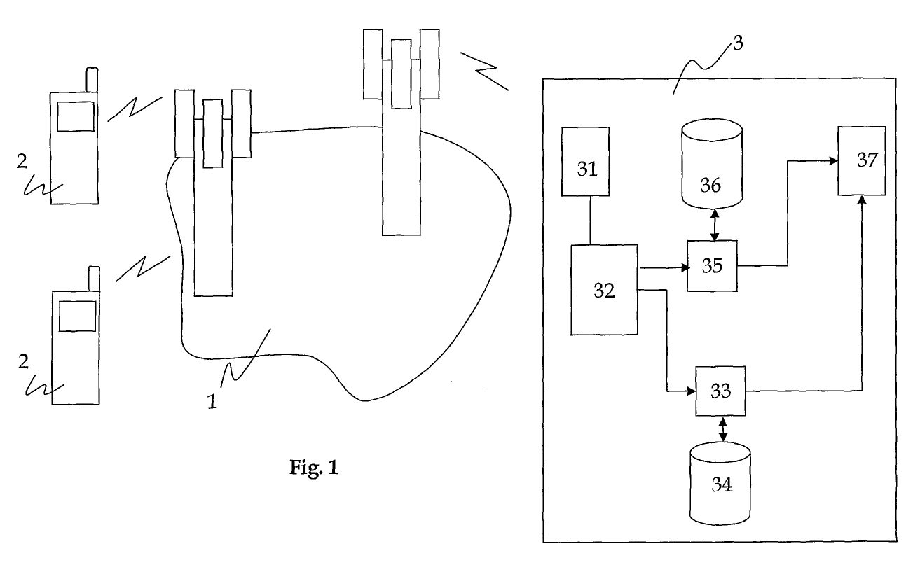

FIG. 1 schematically shows a mobile telephone network;

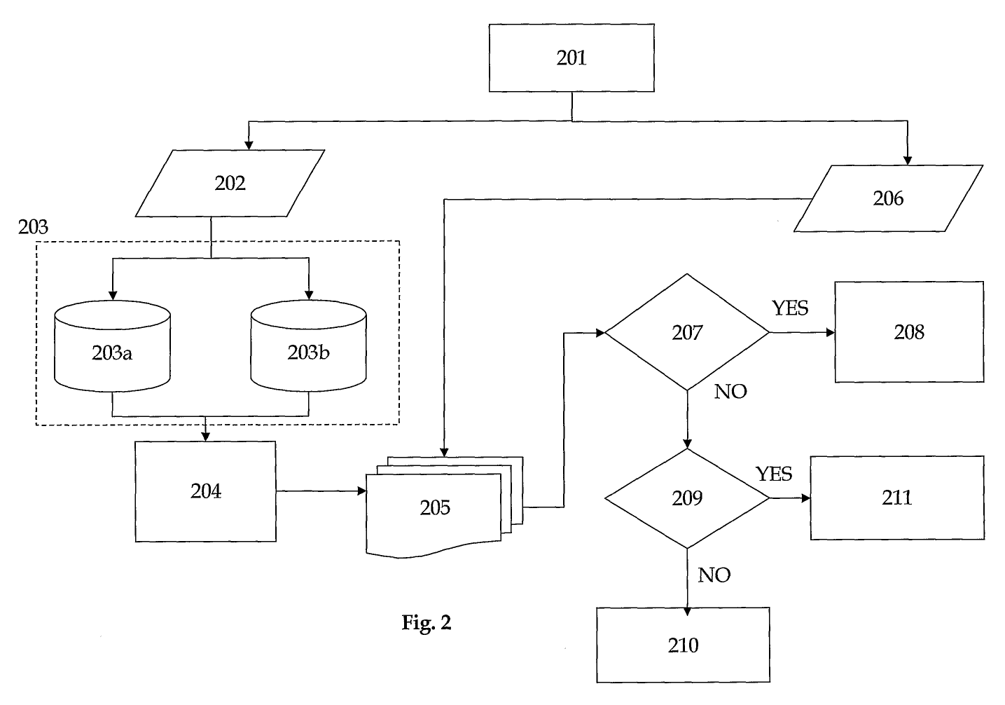

FIG. 2 shows a flow chart relating to a data processing method according to the invention.

FIG. 1 illustrates a mobile telephone network 1 which is accessed in a known manner by user terminals (in particular telephones 2, but also computers fitted with a network connection card).

In the embodiment example shown, the user terminals 2 query a remote processing unit 3 in order to receive return information.

The interrogation of the remote unit takes place by sending a request data string.

In a known manner, the user's request may be generated as an SMS (Short Message System) message or an MMS (Multimedia Message System) message.

Alternatively, the user's request may be placed through access to a WAP or Internet service.

In the preferred embodiment, the user's request is formulated through an SMS or MMS type request message.

The following description will refer simply to a request message, this latter term including the above-mentioned methods for requesting information to a remote electronic unit.

The electronic unit 3 comprises a reception module 31 for receiving request messages sent by a user terminal 2 over the mobile telephone network 1.

The received request message is supplied to a decoder module 32 communicating with said reception module 31 and adapted to extract the following information from the received request message:
the telephone number of the user terminal,
a text (meaning an alphanumerical sequence) contained in the message.

Based on the processing of the request message carried out by the decoder module, a processing module 33 communicating with said decoder module searches a database 34 for the information requested by the user terminal 2 through the request message.

Subsequently or simultaneously, a language selection module 35 determines which language must be used for writing the reply message.

In order to perform this task, the language selection module 35 has access to a data bank 26 containing a plurality of linguistic dictionaries.

The data banks 34 and 36 may be the same.

The electronic processing unit 3 also comprises a reply module 37 which, depending on the language selected by the language selection module 35 and on the information found by the processing module 33, generates and sends a reply message to said user.

Said reply message may possibly include an error message.

According to the invention, the reply message is generated with a text in at least one language defined on the basis of one or more features associated with said request message.

As shown below in detail, the features associated with the message may be, for example:
the country code,
the identifier of the GSM subgroup,
the language of the text contained in the received request message.

FIG. 2 is a flow chart showing the logics that lead to choosing a language for writing the reply message to be sent to the user terminal by the electronic unit. The request message is received (201) and the decoder module extrapolates the caller's telephone number and the text content of the message.

The telephone number (202), e.g. 0039 347 1234567, is analyzed (203) by processing the digits thereof.

In particular, the country code is extracted, e.g. 0039, in order to search a country codes database 203a for the subscription country of the SIM card used by the user terminal, e.g. Italy.

In mobile telephone networks, the three digits following the country code (e.g. 347) are associated with a telephone company, in particular with that company with which the first subscription was made.

For example, in Italy the number 347 is associated with the telephone company Vodafone® Italia.

Since a country code may identify countries having several languages, according to the invention said three digits can be used in order to carry out a search in a telephone companies database 203b. Finding the company with which the first subscription was made (e.g. Vodafone® Italia) allows to identify the subscription country of the SIM card used by the user terminal.

By analyzing the telephone number, the subscription country of the SIM card used by the user terminal (204) is thus determined.

Subsequently, step 205, the language spoken in said subscription country is identified and then it is possible to select a corresponding linguistic dictionary, hereafter referred to as subscription dictionary, contained in the database.

For the purposes of the present description, the term dictionary will hereafter refer to a set of words and phonemes (e.g. corresponding to abbreviations of words, such as “BENZ” or “BEN.” for BENZINA) with which a definition is not necessarily associated. According to the application, a dictionary may therefore comprise a very limited set of “keywords” or at the very least even just a single word or abbreviation.

At the same time as or following the telephone number analysis, a word, in particular the first one, is selected from the text of the received message (step 206).

The selected word is searched for in the subscription dictionary chosen by analyzing the telephone number.

Advantageously, similar words may also be looked up in addition to the selected word, so that if the word “BENZIN” is selected in the message, the word “BENZINA” will be found in the dictionary.

If the selected word is found in the subscription dictionary, then the process will proceed to step 208 and a reply message will be written in the recognized language.

If the selected word is not found in the subscription dictionary chosen according to the telephone number, then a search cycle will be carried out (step 209) for looking up the selected word in the other dictionaries available in the database.

If the word is still not found at the end of the search process (step 211), then a reply message will be written in the language of the subscription dictionary.

This choice (or equivalent choices) offers the advantage that the reply is written in a language presumably spoken by the user of the user terminal, since he/she has a SIM card registered in a country using that language and/or because he/she used that language for writing the request message.

If at the end of the dictionary search process according to step 209 the word is found in several dictionaries, then the reply message (step 211) will be written in the identified languages as well as in the language of the subscription country.

Thus a reply message is written which contains a text made up of at least two portions, one of said portions being the translation of the other.

This solution allows to increase the chances of sending a reply message which can be understood and therefore used by the user terminal 2.

The advantages and features of the present invention are apparent from the description of a preferred and advantageous embodiment of the present invention.

It is nonetheless clear that further variations and changes may be made thereto by those skilled in the art without departing from the principle of the present invention as described and claimed.

The above-described embodiment example referred to user terminals having access to a mobile telephone network and sending an SMS message to a remote data processing unit.

It is known that nowadays also fixed telephone network terminals can send request messages according to the present description. For example, through a computer or a fixed telephone handset it is now possible to send SMS messages directly over the fixed telephone network.

After the necessary routing, the fixed network company sends the SMS message to the mobile network company in order to deliver it to a user.

It is therefore apparent that the present description is not limited to the case wherein a request message is sent by a user terminal.

In the above-described embodiments, the only constraint is that the request message must be associated with a telephone number based on which a language is selected.

In another advantageous embodiment, the message can be first received by a third party, e.g. an electronic processing unit of the telephone network company, which identifies the caller's position, associates this information with the transmitted message, and then sends it to the electronic processing unit 3, possibly even in a different form (e.g. a data or text file).

In this case, the transmission of the request message from said third party to the electronic processing unit 3 may also take place over a fixed telephone network.

Here, the electronic processing unit shall be provided with a reception module 31 which can receive request messages from the fixed telephone network and/or from the mobile telephone network.

Furthermore, according to another advantageous embodiment, the message sent by the user terminal can be received by a third party, in particular an electronic processing unit of the telephone network company, which identifies the position of the user terminal.

Said electronic processing unit of the telephone company associates this position information with the message sent by the user terminal, and then re-sends a message to the electronic processing unit 3.

In this embodiment, the reply message can be written according to a variant of the above-described method. In addition or as an alternative to the analysis of the telephone number (steps 202 to 205), said variant provides for finding a basic dictionary (to be used in step 207) based on the information about the position of the user terminal. As said, this information is associated with the message sent by the electronic processing unit of the telephone company, and is a peculiar feature of the request message coming from the user terminal.

In another advantageous embodiment, a feature associated with the message which can be used for selecting a language for generating the reply message may be a word or an abbreviation of a geographical place, e.g. the name or abbreviation of a city or a country.

In fact, the user terminal may send a request message with a text containing the abbreviation IT to tell the data processing unit that the reply should be in Italian.

Preferably, the language selection module carries out a search for the word or abbreviation extracted from the message (e.g. IT) in a dedicated database.

It is also clear that, as is apparent to the man skilled in the art, the aforementioned single modules and databases may be combined and connected in various ways; for example, the databases may be unavailable locally, but queried remotely via a modem of the remote processing unit, and the functions provided by the above-described modules may be carried out by different computers communicating with one another. In this embodiment, which advantageously allows resources to be shared, the term data processing unit may also mean, in a broader sense, a computer network.

1-27. (canceled)

28. A data processing unit comprising:
a reception module for receiving request messages sent by a user terminal over a telephone network;
a decoder module, in communication with said reception module, adapted to extract a telephone number of the user terminal; and
a reply module that generates a reply message containing a text in at least one language defined on the basis of said telephone number.

29. A data processing unit according to claim 28, wherein said language is defined on the basis of a country code.

30. A data processing unit according to claim 28, wherein said language is defined on the basis of digits of the telephone number that identify a telephone company.

31. A data processing unit according to claim 28, wherein said reply message contains a text including at least two portions, one of said portions being a linguistic translation of the other.

32. A data processing unit according to claim 31, further comprising a database containing at least one dictionary.

33. A data processing unit according to claim 32, further comprising a language selection module configured to identify a first dictionary based on an analysis of a telephone number extracted from the request message.

34. A data processing unit according to claim 33, wherein said decoder module extracts a text contained in the request message, wherein a language selection module is adapted to search said at least one dictionary for a word or an abbreviation contained in the text of said request message, and wherein said reply message is generated with a text written in at least one language defined on the basis of the results of said search.

35. A data processing unit according to claim 28, wherein said request message is an SMS or MMS type message or the like.

36. A data processing unit according to claim 28, wherein said reply module is configured to send a reply message to said user terminal over a telephone network, or said telephone network over which the corresponding request message was sent.

37. A data processing unit according to claim 28, wherein said decoder module is adapted to extract a text contained in the request message, and wherein the data processing unit further comprises a processing module communicating with said decoder module and with a database to search said database for information depending on the text of said request message.

38. A data processing unit comprising:
a reception module for receiving request messages sent by a user terminal over a telephone network;
a decoder module, in communication with said reception module, adapted to extract a telephone number of the user terminal; and
a reply module for generating a reply message containing a text in at least one language defined on the basis of a position of the user terminal.

39. A data processing method for telephone networks, wherein a user terminal sends an information request message to a data processing unit over a telephone network, and wherein said data processing unit carries out:
reception of said request message;
extraction of a telephone number of said user terminal from said request message; and
generation of a reply message with a text in at least one language defined on the basis of said telephone numbers.

40. A method according to claim 39, wherein said language is defined on the basis of a country code.

41. A method according to claim 39, wherein said language is defined on the basis of digits of the telephone number that identify a telephone company.

42. A method according to claim 39, wherein said reply message contains a text including at least two portions, one of said portions being a translation of the other.

43. A method according to claim 42, further comprising identifying a first dictionary based on an analysis of a telephone number extracted from a request message.

44. A method according to claim 43, further comprising searching on at least one dictionary for a word or an abbreviation contained in the text of said request message.

45. A method according to claim 44, wherein said reply message is generated with a text written in at least one language defined on the basis of the results of said search.

46. A method according to claim 39, wherein said request message is an SMS or MMS type message or the like.

47. A method according to claim 39, further comprising sending said reply message to said user terminal over a telephone network, or said telephone network over which the corresponding request message was sent.

48. A method according to claim 39, further comprising searching a database for information based on the text contained in said request message.

49. A method according to claim 39, further comprising detecting the position of the user terminal and generating said reply message with a text in at least one language defined on the basis of the position of the user terminal.

50. A data processing method for telephone networks, wherein a user terminal sends an information request message to a data processing unit over a telephone network, and wherein said data processing unit carries out:
reception of said request message;
extraction of a telephone number of said user terminal from said request message, and
generation of a reply message with a text in at least one language defined on the basis of a position of said user terminal.
